(19) United States
(12) Patent Application Publication
(10) Pub. No.: US 2015/0128417 A1
(43) Pub. Date: May 14, 2015

(54) TURBINE BLADE REMOVAL TOOL AND METHOD THEREOF

(71) Applicant: MITSUBISHI HITACHI POWER SYSTEMS AMERICAS, INC., Lake Mary, FL (US)

(72) Inventor: Tobin Laborde, Winter Park, FL (US)

(73) Assignee: MITSUBISHI HITACHI POWER SYSTEMS AMERICAS, INC., Lake Mary, FL (US)

(21) Appl. No.: 14/540,430

(22) Filed: Nov. 13, 2014

Related U.S. Application Data
(60) Provisional application No. 61/903,743, filed on Nov. 13, 2013.

(51) Int. Cl. B23P 19/04; F01D 5/00; B23P 15/00

(52) U.S. Cl. CPC B23P 19/04; B23P 15/006; F01D 5/005; F05D 2230/70
USPC 29/889.1; 29/281.6; 29/252

(57) ABSTRACT

An apparatus for removing a turbine blade, the apparatus including a main body having a front plate including at least one securing opening for receiving a securing bolt, a rear plate having a fixture groove, and first and second side plates, and a base block configured to slide along the fixture groove of the rear plate.

### CROSS-REFERENCE TO RELATED APPLICATION

This application is based upon and claims priority under 35 U.S.C. 119(e) to Provisional Application No. 61/903,743 filed Nov. 13, 2013, the contents of which are incorporated herein by reference in its entirety.

### FIELD OF THE INVENTION

The present invention relates to an apparatus for safely and carefully removing seized or stuck turbine blades or buckets, which are problematic to remove when they become seized in the rotor during their life cycle.

### BACKGROUND OF THE INVENTION

Prior art techniques for removing a seized turbine blade include using a hammer to strike a piece of brass or similar material placed against the seized blade in order to loosen it for subsequent extraction. However, using a hammer may cause damage to the turbine disc, the blade being removed and neighboring blades.

### SUMMARY OF THE INVENTION

In view of these circumstances, an object of the present invention is to provide a blade removal tool to remove seized turbines blades in order to eliminate the risk of damaging the turbine disc and any turbine blades. The blade removal tool may be used in all types of turbine engines, including gas turbine engines, steam turbine engines, aircraft engines, and others.

In accordance with one aspect of the present invention the blade removal tool comprises a main body including a front plate including at least one securing opening for receiving a securing bolt, a rear plate having a fixture groove, first and second side plates, and a base block configured to slide along the fixture groove of the rear plate.

According to another aspect of the present invention, the base block includes a rear side configured to receive a sliding bolt, the fixture groove includes a groove opening, and the sliding bolt is received in the rear side of the base block through the grove opening. According to another aspect of the present invention, the base block includes a front side with an incline surface.

According to another aspect of the present invention, the blade removal tool further comprises a pusher block that includes a mounting pocket, a ram having an actuated state and a non-actuated state, the ram including: a mounting end, a base portion, an extending arm; a pushing end, and an input valve, wherein in the actuated state the extending arm protrudes from the base portion.

According to another aspect of the present invention, the front plate includes an elongated opening. According to another aspect of the present invention, the ram is mounted on the base block by positioning the mounting end of the ram on the incline surface of the front side of the base block. According to another aspect of the present invention, the pushing end of the ram is positioned in the mounting portion of the pusher block. According to another aspect of the present invention, the ram is hydraulic and is capable of being actuated by a pump, wherein in the actuated state the extending arm of the ram passes through an elongated opening of the front plate.

According to another aspect of the present invention, the pusher block has a substantially same shape as a blade root of the turbine blade. According to another aspect of the present invention, the groove and the groove opening extend along a length of the rear plate. According to another aspect of the present invention, the front and rear plate each have substantially the same radius of curvature.

According to another aspect of the present invention, the main body is secured to a turbine rotor via the securing opening by receiving the securing bolt. According to another aspect of the present invention, the front plate includes a plurality of securing opening each for receiving a securing bolt and the main body is secured to a turbine rotor via the plurality of securing opening by each receiving a securing bolt.

According to another aspect of the present invention, a method of removing a turbine blade in the above discussed aspects, comprises securing the main body to a turbine rotor via the securing opening by receiving the securing bolt, installing the base block in the fixture grove of the rear plate by receiving the sliding bolt, through the groove opening, in the rear side of the base block, mounting the ram on the base block by positioning the mounting end of the ram on the incline surface of the front side of the base block, placing the pusher block in a blade groove of a turbine blade that is to be removed, providing the pusher end of the ram in the mounting pocket of the pusher block, and actuating the ram such that the extending arm protrudes from the base portion and the pusher end of the ram pushes the base block against the root of the blade root.

According to another aspect of the present invention, a method of removing a turbine blade in above discussed aspects, comprises securing the main body to a turbine rotor via the securing opening by receiving the securing bolt, installing the base block in the fixture grove of the rear plate by receiving the sliding bolt, through the groove opening, in the rear side of the base block, mounting the ram on the base block by positioning the mounting end of the ram on the incline surface of the front side of the base block, placing the pusher block in a blade groove of a turbine blade that is to be removed, providing the pusher end of the ram in the mounting pocket of the pusher block through the elongated opening of the front plate, and actuating the ram such that the extending arm protrudes from the base portion and the pusher end of the ram pushes the base block against the root of the blade root.

According to another aspect of the present invention, the method of removing a turbine blade further comprises adjusting the position of the base block in the fixture groove in order to properly mount the ram against the incline surface of the base block.

### BRIEF DESCRIPTION OF THE DRAWINGS

These and other objects and advantages of the present invention will be more concretely understood and appreciated by careful study of the following more detailed description of exemplary embodiments of the invention taken in conjunction the accompanying drawings, in which:

FIG. 1 is elevational view of a blade removal tool in accordance with an embodiment of the present invention;

FIG. 2 is perspective view of a blade removal tool in accordance with an embodiment of the present invention;

FIG. 3 is a fragmented perspective view of a turbine blade being removed by a blade removal tool in accordance with an embodiment of the present invention;

FIG. 4 is perspective view of a main body of a blade removal tool in accordance with an embodiment of the present invention;

FIG. 5A is an elevational bottom view of a pusher block in accordance with an embodiment of the present invention;

FIG. 5B is an enlarged perspective view of a pusher block in accordance with an embodiment of the present invention;

FIG. 6 is a perspective view of unassembled blade removal tool in accordance with an embodiment of the present invention;

FIG. 7 is a fragmented perspective view of turbine blades in the first and second row according to an embodiment of the present invention;

FIG. 8 is a fragmented perspective left and right views of a mounting location on a rotor disc according to an embodiment of the present invention;

FIG. 9 is a fragmented perspective view of a main body secured to a rotor disc according to an embodiment of the present invention;

FIG. 10 is a fragmented perspective view of a base block being secured to the main body by a sliding bolt according to an embodiment of the present invention;

FIG. 11 is a perspective view of a hydraulic pump attached to a ram.

FIG. 12 is an enlarged elevation view of a ram mounted in a main body in an actuated state according to an embodiment of the present invention;

FIG. 13 is an enlarged fragmented elevation view of a turbine blade being removed according to an embodiment of the present invention;

FIGS. 14A and 14B are fragmented elevation views illustrating the removal of turbine blades located in a second row.

### DETAIL DESCRIPTION OF THE PREFERRED EMBODIMENTS

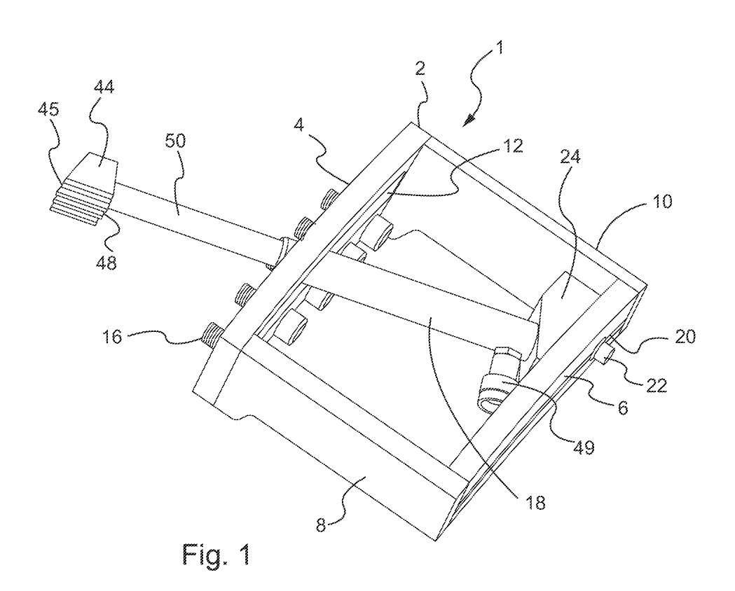

FIG. 1 illustrates an embodiment of a blade removal tool 1 according to an aspect of the present invention. As shown in FIGS. 1, 4 and 6, the blade removal tool 1 includes a main body 2, which is comprised of four plates, a front plate 4, a rear plate 6 and two side plates 8, 10. The front, rear and two side plates 4, 6, 8 and 10 are welded together at substantial right angles to form the main body 2.

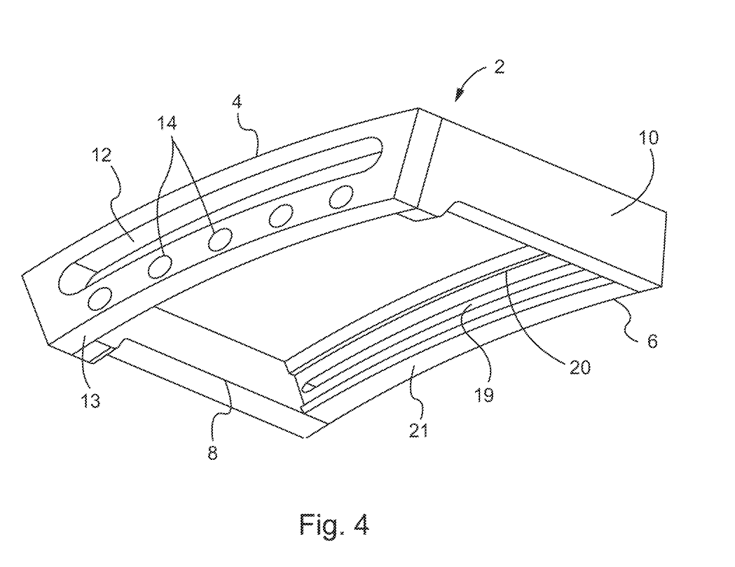

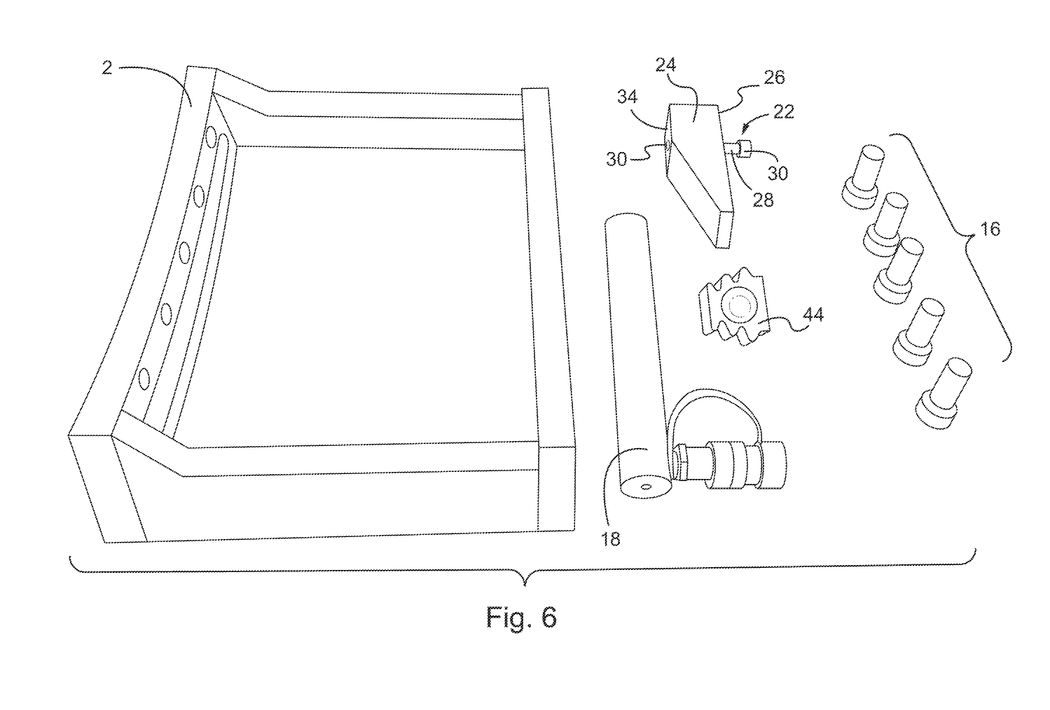

As shown in FIGS. 1, 4 and 6, the front plate 4 of the main body has an elongated opening 12 and a plurality of securing opening 14 provided below the elongated opening 12. The securing openings 14 may be of same size and may be provided equal distance a part from each other. The front plate 4 is also provided with a radius of curvature, for example, of 30 degrees. The plurality of securing opening 14 are provided such that securing bolts 16, for example as shown in FIG. 6, can be used to fasten the main body 2 to a rotor of a turbine. As shown in FIGS. 1 and 4, the elongated opening 12 is provided in the front plate 4 to allow a hydraulic ram 18 to pass through it and to allow an operator to move the position of the ram 18, if needed, along the elongated opening 12 in order to remove a turbine blade, as discussed more fully below.

As also shown in FIG. 1, the rear plate 6 also has a radius of curvature which is substantially similar to that of the front plate 4, for example, 30 degrees. In addition, as shown in FIGS. 1, 4 and 10 the rear plate 6 has a fixture groove 20, which includes a groove opening 19 in the rear plate for accommodating a sliding bolt 22, which is able to slide along the groove opening 19 in the rear plate 6. The fixture groove 20 and the groove opening 19 extend along the entire length of the rear plate 6,

In addition, the blade removal tool 1 also includes a base block 24, as shown in FIGS. 1 and 6. The base block 24 has a substantially flat rear side 26, which includes threads for receiving the sliding 22 bolt (for example a 12 mm bolt). As shown in FIG. 6, the sliding bolt 22 has a smaller inner diameter portion 28 and a larger outer diameter or head portion 30. The end of the inner diameter portion 28 has screw threads, which enables it to be screwed into the rear side 26 of the base block 24 through the groove opening 19 of the fixture groove 20. base block 24 with the sliding bolt 22 are accommodated into the fixture groove 20 of the rear plate 6, which allows the base block 24 to slide along the inner wall of the rear plate 6. In other words, the base block 24 is configured to slide along the fixture groove 20 and the rear side 26 of the base block 24 is configured to receive the sliding bolt 22. The front side 34 of the base block 24 includes an incline surface 36 for receiving a ram 18, which, for example, maybe hydraulic. As discussed more fully below, the angle of the incline surface 36 of the front side 34 of the base block 24 is machined to have the same angle as blade grooves in a rotor disc.

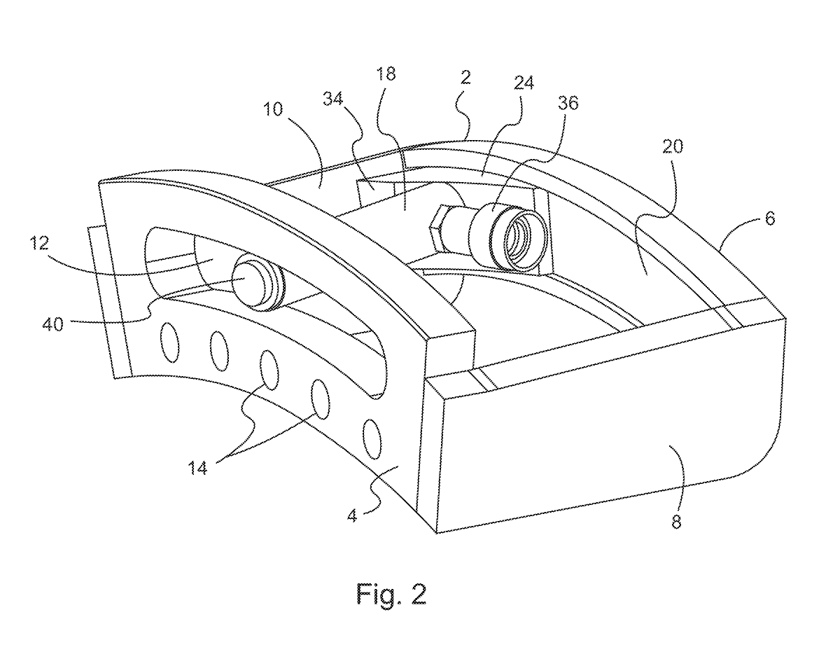

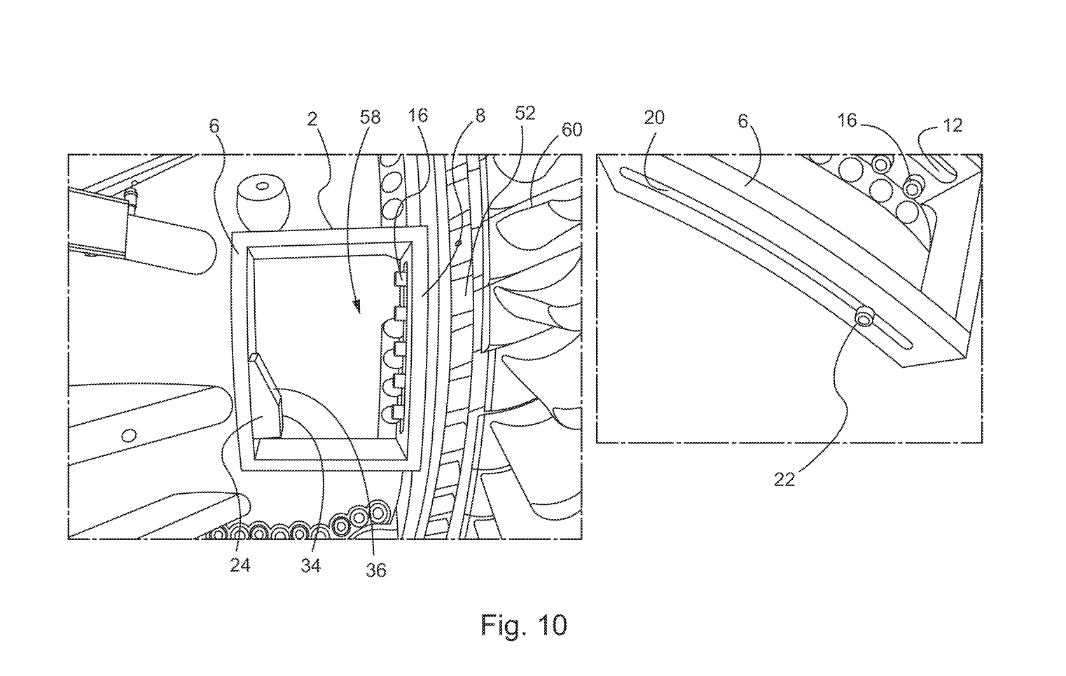

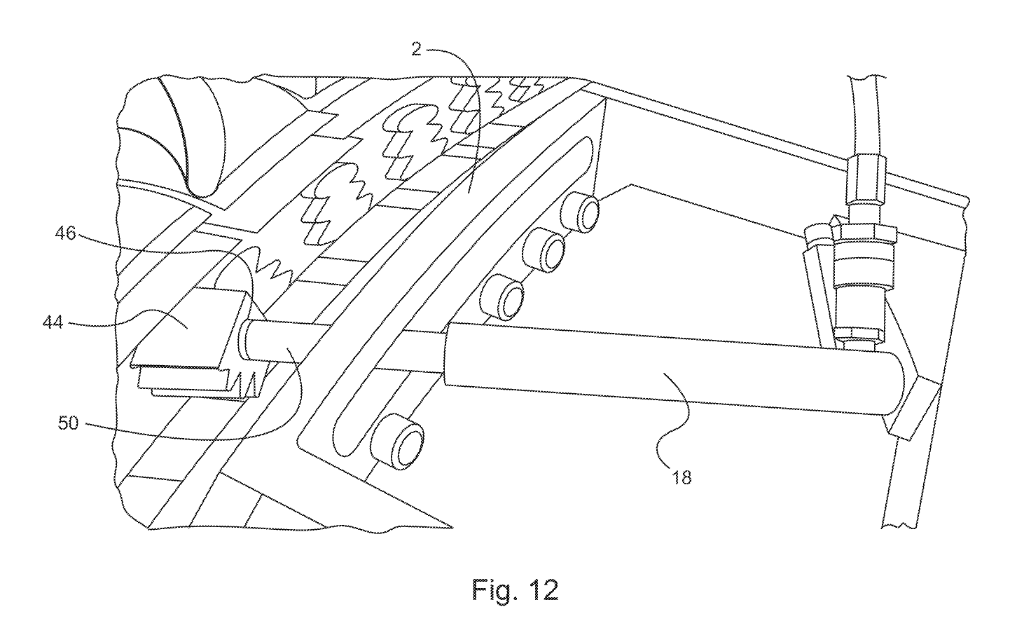

FIG. 2 illustrates an example according to an aspect of the present invention of a main body 2 having the base block 24 install on the rear plate 6 with a mounting end 38 of a hydraulic ram 18 positioned on the incline surface 36 of the front side 34 of the base block 24 and a pushing end 40 of the hydraulic ram 18 passing through the elongated opening 12 of the front plate 4. More specifically, the hydraulic ram 18 shown in FIG. 2 is in a non-actuated state. As shown in FIGS. 2 and 10, when the sliding bolt 22 is received by the base block 24, which is accommodated in the fixture groove 20 of the rear plate 4, the smaller inner diameter portion 28 of the sliding bolt 22 is configured to slide along the groove opening 19 while the head portion 30 is exterior to the rear plate 6. That is, the rear side 26 of the base block 24 is able to slide along the rear plate 6 of the main body 2 and the incline surface 36 of the front side 34 of the base block 24 faces the elongated opening 12 of the front plate 4 of the main body 2 offset by the angle of the incline surface 36. FIG. 6 illustrates an example of a hydraulic ram 18 according to an aspect of the present invention that can be used with the blade removal tool 1 to remove a seized turbine blade. As shown in FIG. 12, the hydraulic ram 18 can be actuated, for example, by the use of a hand pump 42, for example, with a maximum pressure of 10,000 psi. When the hand pump 42 is attached to an input valve 49 and the hydraulic ram 18 goes from a non-actuated state to an actuated state, an extending arm 50 protrudes from a base portion of the hydraulic ram 18, as shown in FIG. 1.

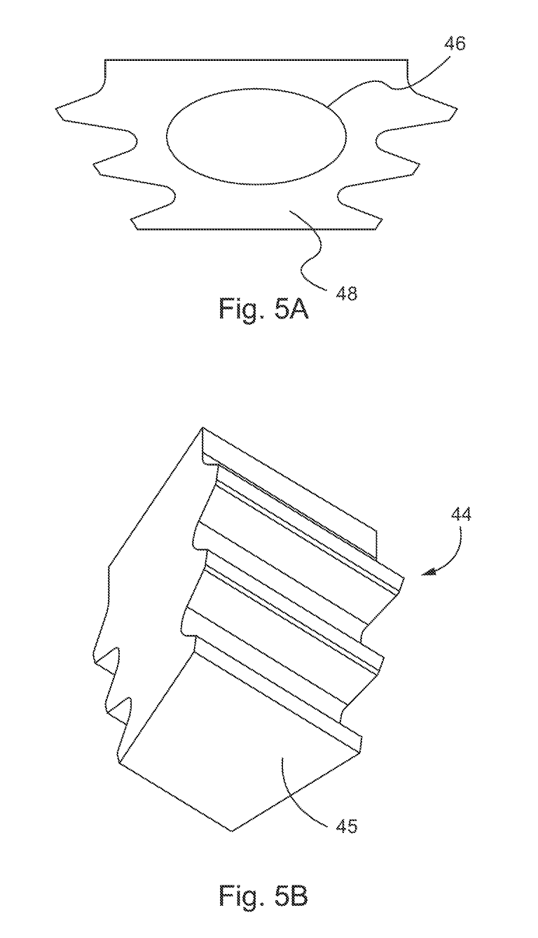

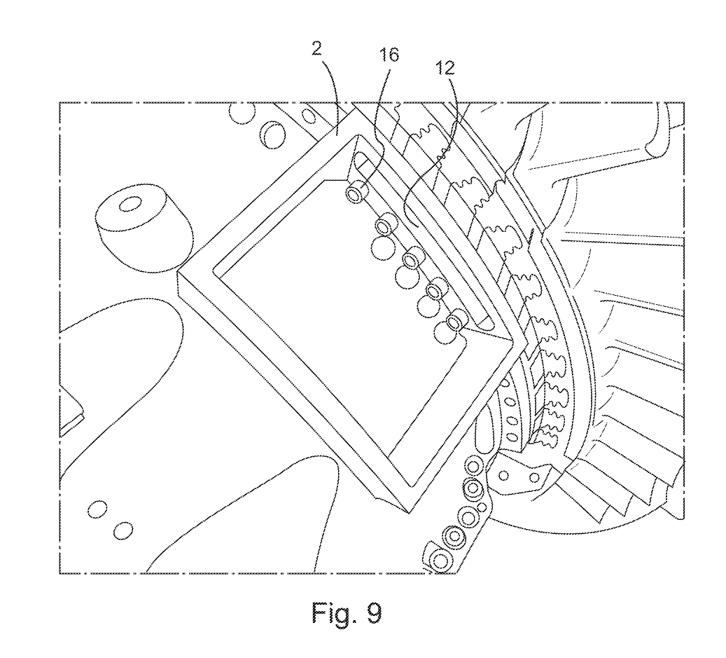

FIG. 6 also illustrates an example of a pusher block 44 that can be used with the blade removal tool 1 to remove a seized turbine blade. The pusher block 44 can be made of brass, nickel or similar material and is machined to include a mounting pocket 46, as shown in FIG. 5, on its rear surface 48 for receiving a pushing end 40 of the extending arm 50 of the ram 18. In addition, the pusher block 44 is also machined to have the same shape or profile as the root of the turbine blade that is being removed. For example, FIG. 5 shows an example of a pusher blade 44 having a fir tree profile or shape, such that the pusher block 44 can have the same shape as the blade root 52 of the turbine blade 54 that is to be removed, as shown in FIGS. 9 and 12. Having the pusher block 44 machined into the same shape as the blade root 52 allows for the pusher block 44 to be placed into the blade groove 56 in the rotor disc 58 for the turbine blade 54 that is to be removed. That is, when the pusher block 44 has the same profile as the blade root 52, the pusher block 44 placed in the blade groove 56 can properly be pushed against the blade root 52 when the extending arm 50 of the ram 18 contacts the mounting pocket 46 on the rear surface 48 of the pusher block 44. More specifically, a top surface 45 of the pusher block 44 makes contact with the blade root 52 during removal of a turbine blade 54.

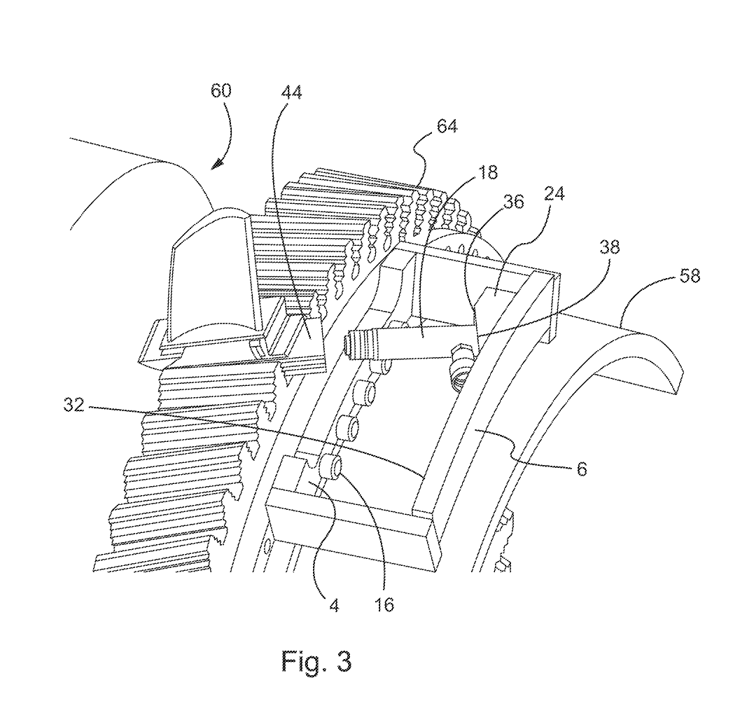

FIG. 3 illustrates an example according to an aspect of the present invention of the main body 2 being secured to the rotor 58 of the turbine 60 by using securing bolts 16 in the plurality of securing opening 14 of the front plate 4, the base block 24 being installed in the fixture groove 20 of the rear plate 6 of the main body 2, the mounting end 38 of the ram 18 being positioned on the incline surface 36 of the base block 22 and the pusher block 44 being provided in the blade groove 56 of the turbine blade 54 that is to be removed. In addition, as shown in FIG. 3, the incline surface 36 of the base block 24 and the rear surface 48 of the pusher block 44 provided in the blade groove 56 are substantially parallel to each other. This is because the angle of the incline surface 36 of the front side 34 of the base block 24 is machined to be the same angle as the blade grooves 56 in the rotor disc 58 (for example, 23 degrees). This allows the extending arm 50 of the ram 18 to contact the mounting pocket 46 on the rear surface 48 of the pusher block 44 at substantially a 90 degree angle, which is ideal for eliminating damage to the rotor disc 58 during the removal of the turbine blade 54.

Of course, it is understood that the main body 2 can be used with a plurality of base blocks 24 each having its incline surface machined to have the same angle and the blade grooves 58 for the turbine blade 54 to be removed. As well, it is also understood that the pusher block 44 can be machined to match any profile that a blade root 52 may have. Furthermore, it is understood that a single securing opening 14 may be used to secure the main body 2 to the rotor 58 instead of a plurality of securing openings 14. Also, as shown in FIG. 3, it is understood that the front plate 4 does not necessarily have to include an elongated opening 18 and that the ram 18 is able to pass over an upper surface of the front plate 4.

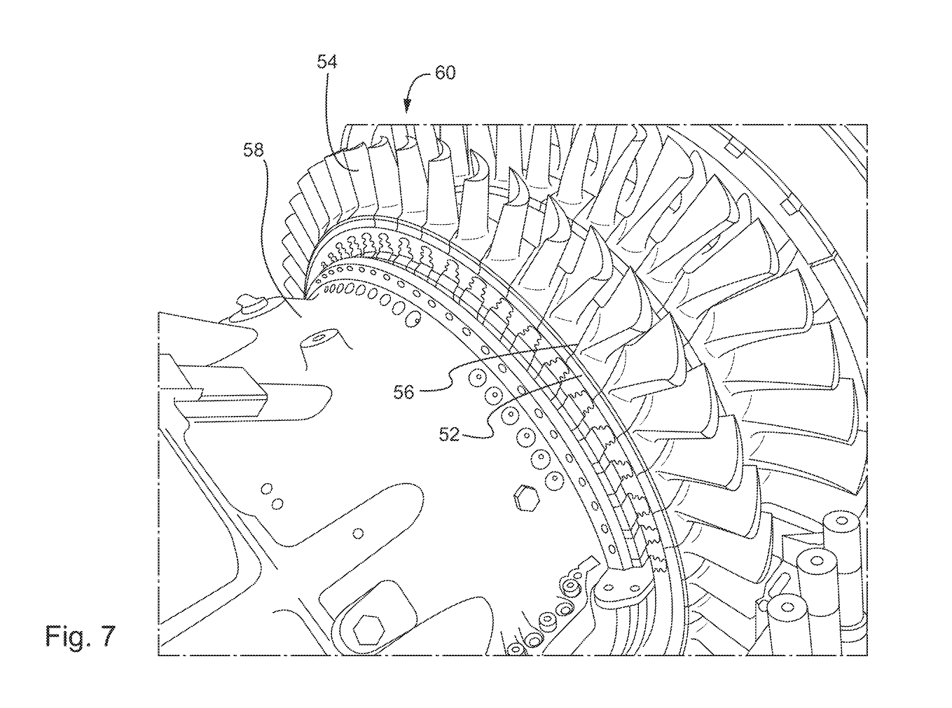

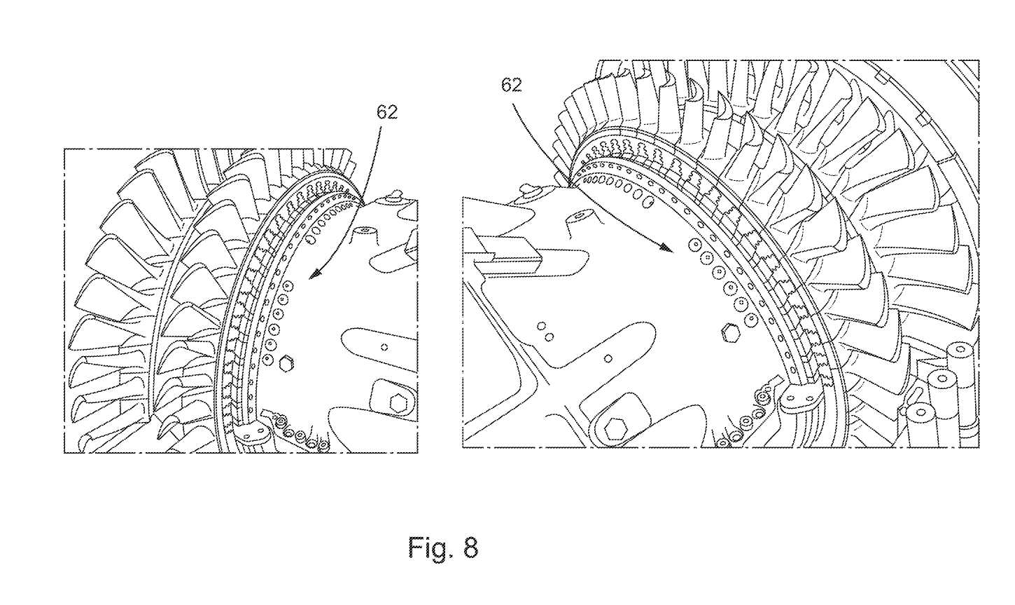

FIGS. 7-13 illustrate an example or method according to an aspect of the invention of how the blade removal tool 1 or apparatus can be used by a field operator to remove a seize turbine blade 54 located in either a first row 64 or second row 66. First, as shown in FIG. 7, in order for the blade removal tool 1 to be mounted to the rotor 58 of the turbine 60, the field operator needs to remove some hardware install on the rotor 58, for example, all blade rings, supporting rings and locking hardware for both the first and second rows 64, 66 of the turbine blades 54. The field operator then chooses a suitable mounting location for the main body 2 on the rotor 58, as shown in FIG. 8. Next, as shown in FIG. 9, the main body 2 is installed to the rotor 58 of the turbine 60, for example, by securing the securing bolts 16 via the securing openings 14 on the front plate 4 of the main body 2 to the upstream side of the torque tube cover 62. Then, the base block 24 is installed on the rear plate 6 of the main body 2, which is upstream of the front plate 4 of the main body 2, by inserting the smaller inner diameter portion 28 of the sliding bolt 22 through the groove opening 19 of the fixture groove 20 of the rear plate 4 and then lightly securing it to the base block 44. The sliding bolt 22 allows the base block 24 to move along the fixture groove 20. The bottoms surfaces of the front and rear plates 13, 21 of the blade removal tool 1 are able to rest on the rotor 58 of the turbine 60, since the front and rear plates 4, 6 each have the same radius of curvature as the rotor 58 of the turbine 60.

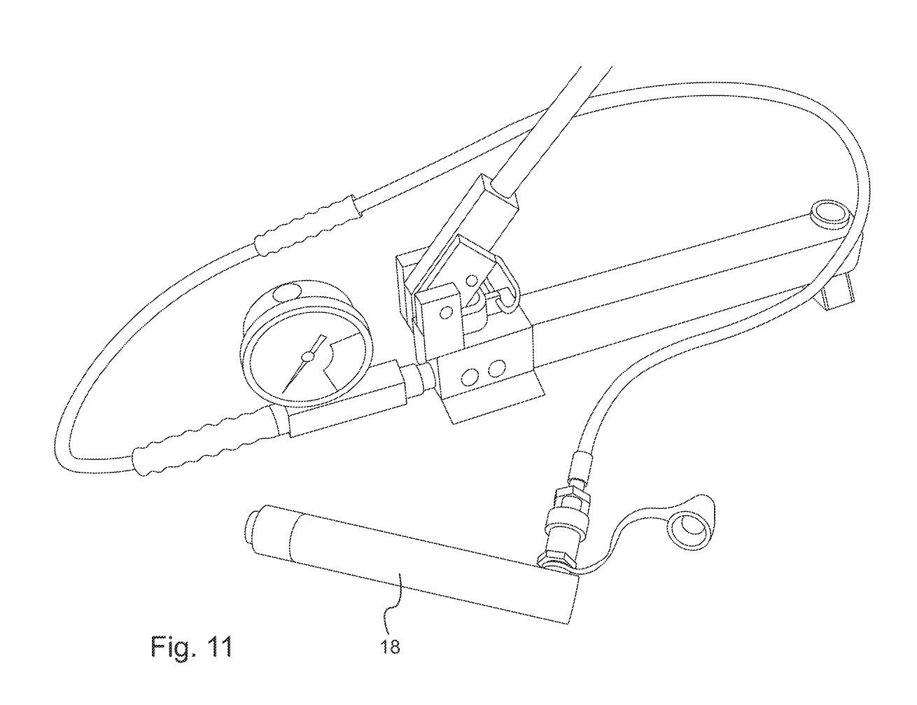

Next, as shown in FIGS. 10 and 11, a hand pump 42 is connected to a the input valve 49 of the ram 18 and the ram 18 is placed in the main body 2 with the mounting end 38 being positioned on the incline surface 36 of the base block 24 and the actuated pushing end 40 of the ram 18 being passed through the elongated opening 12 of the front plate 4 and contacting the mounting pocket 46 on the rear surface 48 of the pusher block 44, which is installed in the blade groove 56. Next, if necessary, the position of the base block 24 is adjusted along the fixture groove 20 until the ram 18 sits squarely against the inclined surface 36 of the base block 24.

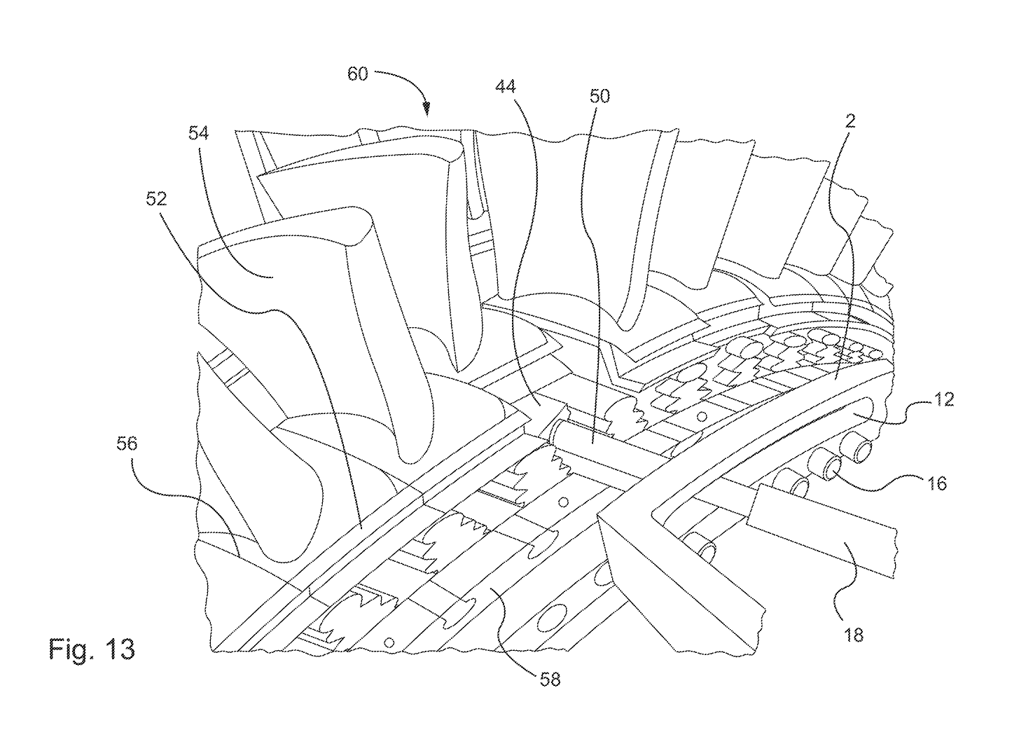

That is, FIG. 12 illustrates the blade removal tool 1 with the base block 24 installed in the fixture groove 20 of the rear plate 6 of the main body 2 and the mounting end 38 of the ram 18 placed flushed against the incline surface 36 of the base block 24 and the pushing end 40 of the ram 18 protruding through the elongated opening 12 of the front plate 4. The incline surface 36 of the base block 24 having an angle (for example of 23 degrees) such that the ram 18 is able to push the pusher block 44 against the blade root 52 at the same angle as the blade grooves 56 in the rotor disc 58 (for example, 23 degrees), as shown in FIGS. 12 and 13.

Then, as shown in FIG. 13, hydraulic pressure is slowly applied to the ram 18 using the hand pump 42 and with the pusher block 44 being lined up properly with the blade groove 56, the turbine blade 54 is pushed out without any damage to the turbine rotor disc 58 or other turbine blades.

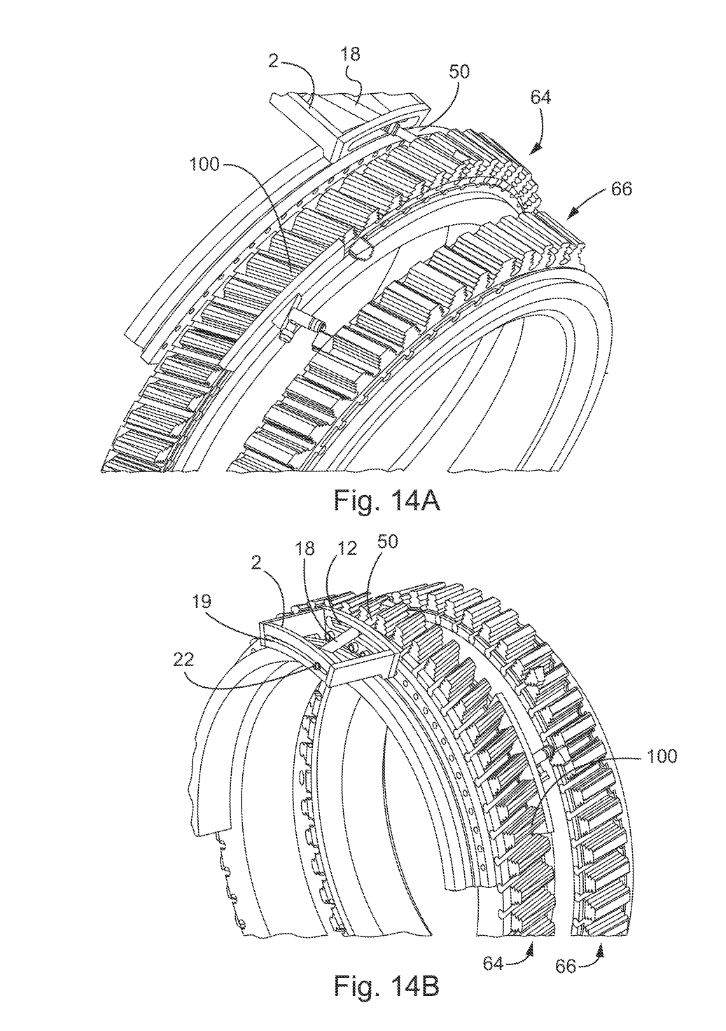

FIGS. 14A and 14B illustrate the removal of blades located in a second row, which can also be used to remove blades in any subsequent rows, for example, third or fourth rows.

From the above description of preferred embodiments of the invention, those skilled in the art will perceive improvements, changes and modifications. Such improvements, changes and modifications within the skill of the art are intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

### LIST OF REFERENCE ELEMENTS

Blade removal tool 1, main body 2
Front plate 4, elongated opening 12, bottom surface 13, securing openings 14
Rear plate 6, fixture groove 20, groove opening 19, bottom surface 21, inner surface 32
Side plates 8, 10
Securing bolts 16
Ram 18, mounting end 38, pushing end 40, input valve 49, extending arm 50,
Sliding bolt 22, smaller inner diameter portion 28, head portion 30
Base block 24, rear side 26, front side 34, incline surface 36
Hand pump 42
Pusher block 44, mounting pocket 46, top surface 45, rear surface 48
Blade root 52, turbine blade 54,
Blade groove 56,
Rotor disk 58
Turbine 60
Upstream side of the torque tube cover 62
First row 64
Second row 66

We claim:

1. An apparatus for removing a turbine blade, the apparatus comprising:
a main body including:
a front plate including at least one securing opening for receiving a securing bolt;
a rear plate having a fixture groove; and
first and second side plates; and
a base block configured to slide along the fixture groove of the rear plate.

2. The apparatus for removing a turbine blade according to claim 1, wherein
the base block includes a rear side configured to receive a sliding bolt,
the fixture groove includes a groove opening, and
the sliding bolt is received in the rear side of the base block through the grove opening.

3. The apparatus for removing a turbine blade according to claim 2, wherein the base block includes a front side with an incline surface.

4. The apparatus for removing a turbine blade according to claim 3, further comprises:
a pusher block that includes a mounting pocket.

5. The apparatus for removing a turbine blade according to claim 4, further comprises:
a ram having an actuated state and a non-actuated state, said ram including: a mounting end; a base portion; an extending arm; a pushing end; and an input valve, wherein in the actuated state the extending arm protrudes from the base portion.

6. The apparatus for removing a turbine blade according to claim 5, wherein the front plate includes an elongated opening.

7. The apparatus for removing a turbine blade according to claim 5, wherein the ram is mounted on the base block by positioning the mounting end of the ram on the incline surface of the front side of the base block.

8. The apparatus for removing a turbine blade according to claim 7, wherein the pushing end of the ram is positioned in the mounting portion of the pusher block.

9. The apparatus for removing a turbine blade according to claim 8, wherein in the actuated state the extending arm of the ram passes through an elongated opening of the front plate.

10. The apparatus for removing a turbine blade according to claim 5, wherein the ram is hydraulic and is capable of being actuated by a pump.

11. The apparatus for removing a turbine blade according to claim 4, wherein the pusher block has a substantially same shape as a blade root of the turbine blade.

12. The apparatus for removing a turbine blade according to claim 1, wherein the main body is secured to a turbine rotor via the securing opening by receiving the securing bolt.

13. The apparatus for removing a turbine blade according to claim 1, wherein the front plate includes a plurality of securing opening each for receiving a securing bolt and the main body is secured to a turbine rotor via the plurality of securing opening by each receiving a securing bolt.

14. The apparatus for removing a turbine blade according to claim 2, wherein the groove and the groove opening extend along a length of the rear plate.

15. The apparatus for removing a turbine blade according to claim 1, wherein the front and rear plate have substantially the same radius of curvature.

16. A method of removing a turbine blade in the apparatus of claim 5, comprising the steps of:
securing the main body to a turbine rotor via the securing opening by receiving the securing bolt;
installing the base block in the fixture grove of the rear plate by receiving the sliding bolt, through the groove opening, in the rear side of the base block;
mounting the ram on the base block by positioning the mounting end of the ram on the incline surface of the front side of the base block;
placing the pusher block in a blade groove of a turbine blade that is to be removed;
providing the pusher end of the ram in the mounting pocket of the pusher block; and
actuating the ram such that the extending arm protrudes from the base portion and the pusher end of the ram pushes the base block against the root of the blade root.

17. The method of removing a turbine blade according to claim 16, further comprising the step of:
adjusting the position of the base block in the fixture groove in order to properly mount the ram against the incline surface of the base block.

18. A method of removing a turbine blade in the apparatus of claim 6, comprising the steps of:
securing the main body to a turbine rotor via the securing opening by receiving the securing bolt;
installing the base block in the fixture grove of the rear plate by receiving the sliding bolt, through the groove opening, in the rear side of the base block;
mounting the ram on the base block by positioning the mounting end of the ram on the incline surface of the front side of the base block;
placing the pusher block in a blade groove of a turbine blade that is to be removed;
providing the pusher end of the ram in the mounting pocket of the pusher block through the elongated opening of the front plate; and
actuating the ram such that the extending arm protrudes from the base portion and the pusher end of the ram pushes the base block against the root of the blade root.

19. The method of removing a turbine blade according to claim 18, further comprising the step of:
adjusting the position of the base block in the fixture groove in order to properly mount the ram against the incline surface of the base block.
